(19) United States
(12) Patent Application Publication
(10) Pub. No.: US 2016/0275591 A1
(43) Pub. Date: Sep. 22, 2016

(54) Housecutters.com

(71) Applicant: Andrew T. Muc, Warrington, PA (US)

(72) Inventor: Andrew T. Muc, Warrington, PA (US)

(21) Appl. No.: 14/663,459

(22) Filed: Mar. 20, 2015

(51) Int. Cl. G06Q 30/06

(52) U.S. Cl. CPC G06Q 30/0631; G06Q 30/0633; G06Q 30/0625; G06Q 30/0611

(57) ABSTRACT

The disclosed herein is provide a system and method for facilitating online personalized shopping information for a shopper which provides personalized information about at least one favorite provider of an item, said personalized information including special-sale items and/or services and popular items and/or provided by the at least one favorite provider. In one embodiment of the invention, the method providing personalized collections of at least one favorite item, the personalized collections including a shopping list related to the shopper and a shopping list related to a person other than the shopper. In a preferred embodiment of the invention, the personalized shopping information is provided via an electronic device in the form of a web application or on an online shopping Web page.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

(1) Field of the Invention

The disclosure generally relates to systems and methods for online personalized shopping information for a shopper. More particularly the invention pertains to computer-implemented lawn care service.

(2) Background of Invention

Current online lawn care services' quoting provides customers with a very broad estimate for desired treatment. Generally, the customer will either telephone or request an online quote for a treatment process for their lawn care service. The treatment process may include a lawn treatment, aeration and spot seeding, pest control, and so forth. The services available are provided by the lawn care service provider and the customer will then pick the treatments desired and request a price for those treatments.

Normally, the customer will provide their lot size dimensions, any previous treatment provided by the lawn care service provider, and the desired treatment service. The lawn care service provider will retrieve any information that he has on the customer, couple that information with the lot size information supplied by the customer, and provide an estimate. If the customer is new to the lawn care provider, then the process for getting an estimate can be very extensive and time consuming. Errors can be made in the lot dimensions given by the customer who could be compounded by the lawn care service provider providing an estimate that is inaccurate as based on inaccurate information supplied by the customer.

Very often, in order to prevent the occurrence of errors that can arise due to inaccurate lot dimensions and demographic information provided to the lawn care service provider, the provider may delay an estimate for a few days. The reason for that delay for a few days is to allow a service representative to view the property, and make his own surveillance and data recordation for an accurate quote. Still, errors can arise in the estimate due to incorrect lot dimension measurement by the representative as well as a delay that is caused by the time spent in visiting the property and then having to provide an estimate from memory after reviewing the property and the surrounding circumstances, sometime earlier. Therefore, there is a need in the art for an online lawn care service quoting method that would provide a real time accurate estimate for lawn care services.

Also the present online shopping service providers do not provide personalized and comprehensive online shopping information that is seamlessly connected to the Web pages of online shopping service providers. Currently, online shoppers cannot instantly view their desired products or services from their favorite providers, and do not receive online shopping information about special sales, advertisements, and popular products from such providers, when they sign onto an online shopping service provider's home page.

Current online shopping service providers do not allow online shoppers to search, view, and select an item from an online shopping list that relates to the shopper or another person, when the shopper is browsing the online shopping service provider's home page.

There is a need, therefore, for online shopping service providers that provide online shoppers with the ability to select their favorite shopping categories or providers for their desired products or services, to receive detailed and personalized shopping information about the specials and popular products or services offered by their favorite providers, and to search and view shopping lists that relates to themselves, to friends, or other members of their families. There is also a need for online shopping service providers that attract and retain more offline product or service providers by highlighting detailed information and features about them online.

### BRIEF SUMMARY OF THE INVENTION

The primary objective of the invention is to provide a method for facilitating online personalized shopping information for a shopper which provides personalized information about at least one favorite provider of an item, said personalized information including special-sale items and/or services and popular items and/or provided by the at least one favorite provider. In one embodiment of the invention, the method providing personalized collections of at least one favorite item, the personalized collections including a shopping list related to the shopper and a shopping list related to a person other than the shopper. In a preferred embodiment of the invention, the personalized shopping information is provided via an electronic device in the form of a web application or on an online shopping Web page.

Further in another embodiment of the, invention is a web application or on an online shopping Web page wherein a menu of providers and their related items and/or services they are providing. In the online shopping Web page or the web application a user can select at least one favorite service provider from said directory of providers providing items or services, also the shopping Web page or the web application provides a user with a directory of providers providing items or services.

Furthermore, the present invention is an online computer-implemented lawn care service quoting method using a computer which comprises of providing a lawn care service provider database associated with the computer receiving at the computer a request for lawn care services as an estimate inquiry, posting said estimate inquiry in a web site accessible to a lawn care service provider.

In yet another embodiment of the invention, a user is provided with a search box in said online shopping Web page for searching at least one item from said items provided by said provider, also a user can select at least one favorite item in a shopping list.

Additionally in one embodiment of the invention the online shopping Web page or web application provides information about at least one specialty provider.

Moreover the invention has a computer readable medium embodying the method for providing online shopping information and the method comprises of steps wherein a user can search at least one favorite provider for the shopper and provide information about at least one item in the at least one favorite provider.

Also, in cine embodiment of the invention, the system for providing online shopping assistance which comprises of at least one user terminal, at least one database containing information about providers of shopping items, means for searching at least one favorite shopping category for the shopper, means for searching at least one favorite provider for the shopper, means for providing information about at least one item in the at least one shopping category; and a means for providing information about at least one item provided by the at least one favorite provider.

And the computer system further is implemented on a network environ environment which includes a global telecommunications network.

The summary is provided to introduce a selection of concepts in a simplified form that are further described below in the detailed description. This summary is not intended to identify key features or essential features of the subject matter, nor is it intended to be used as an aid in determining the scope of the subject matter. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### DETAILED DESCRIPTION OF THE INVENTION

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention. The detailed descriptions below are designed to make such embodiments obvious to a person of ordinary skill in the art.

The present invention can be implemented on any communication device that has hardware components that can perform telecommunication such as (but not limited to)—computers (desktop, laptop, tablets), smart phones, personal multimedia devices, etc.

The various devices on which the applications that implement the present invention run may use one or more processors with different instruction-sets, architectures, clock-speeds, etc. and memory that may include high speed random access memory and may include non-volatile memory such as one or more magnetic disk storage devices, flash memory devices and other kinds of solid state memory devices.

The various applications that can implement the present invention run on electronic devices that may use at least one physical user interface device that provide the means of control and navigation within the operating system and applications that run on the devices include (but not limited to) touch-pads such as those described in (but not limited to)—(1) U.S. patent application Ser. No. 10/722,948 (“Touch pad for handheld device”, filed Nov. 25, 2003); (2) U.S. patent application Ser. No. 10/188,182 (“Touch pad for handheld device”, filed Mar. 21, 2006); (3) U.S. patent application Ser. No. 08/210,610 (“Computer system with touchpad support in operating system”, filed Mar. 18, 1994); (4) U.S. patent application No. 643,256 (“Movable touch pad with added functionality”, filed Ser. No. 10/643,256), touch screens such as those described in (but not limited to) (1) U.S. patent application Ser. No. 11/381,313, “Multipoint Touch Surface Controller,” filed on May 2, 2006; (2) U.S. patent application Ser. No. 10/840,862, “Multipoint Touchscreen,” filed on May 6, 2004; (3) U.S. patent application Ser. No. 10/903,964, “Gestures For Touch Sensitive Input Devices,” filed on Jul. 30, 2004; (4) U.S. patent application Ser. No. 11/048,264, “Gestures For Touch Sensitive Input Devices,” filed on Jan. 31, 2005; (5) U.S. patent application Ser. No. 11/038,590, “Mode-eased Graphical User interfaces For Touch Sensitive Input Devices,” filed on Jan. 18, 2005; (6) U.S. patent application Ser. No. 11/228,758, “Virtual Input Device Placement On A Touch Screen User Interface,” filed on Sep. 16, 2005; (7) U.S. patent application Ser. No. 11/228,700, “'Operation Of A Computer With A Touch Screen Interface,” filed on Sep. 16, 2005; (8) U.S. patent application Ser. No. 11/228,737, “Activating Virtual Keys Of A Touch-Screen Virtual Keyboard,” filed on Sep. 16, 2005 and (9) U.S. patent application Ser. No. 11/367,749, “Multi-Functional Hand-Held Device,” filed on Mar. 3, 2006, click wheel such as those described in U.S. patent application Ser. No. 11/549,619 “Method, device, and graphical user interface for dialing with a click wheel” filed on Oct. 13, 2006, keyboards such as those mentioned in (but not limited to) U.S. patent application Ser. No. 07/711,760 (“Ergonomic keyboard input device”, filed on Jun. 6, 1991), mouse such as those described in (but not limited to) (1) application Ser. No. 09/167,314 (“Computer mouse with enhance control button(s)”, filed on Oct. 6, 1998); (2) application Ser. No. 08/288,945 (“Roller mouse for implementing scrolling in windows applications”, filed on Aug. 10, 1994) and gesture recognition means such as those described in (but not limited to) (1) European Patent application publication number: EP2482176 A2 (“Multi-input gesture control for a display screen”, filed on Nov. 4, 2011) and (2) U.S. Patent application with publication number 20120317511 A1 (“DISPLAY WITH BUILT IN 3D SENSING CAPABILITY AND GESTURE CONTROL OF TV”, filed on Aug. 21, 2012).

Display means used by these devices may use LCD (liquid crystal display) technology, LED (light Emitting Diode) technology, CRT (Cathode ray tube) technology, or LPD (light emitting polymer) technology or any other display techriologies. Various realizations of graphics display circuitry that implement a Graphics Processing Unit (GPU) are used to achieve video interface between user and these electronic devices.

Connectivity of these devices with networks such as the internet, an intranet and/or wireless network such as cellular telephone network, a wired or wireless local area network (LAN) and/or metropolitan area network (MAN) and/or WAN (wide area network) and other wireless communication is achieved by use of a plurality of communication standards, protocols and technologies like Global System for mobile communication (GSM), Enhanced Data GSM Environment (EDGE), wideband code division of multiple access (W-CDMA), DLNA, LTE (Long Term Evolution), code division of multiple access (COMA), time division multiple access (TDMA), Bluetooth, Wireless Fidelity (Wi-Fi) and/or any other suitable communication protocol, including communication protocols not yet developed as of the filing date of this document.

The present invention maybe implemented on applications that run on a single or variety of operating system platforms including but not limited to OS X, WINDOWS, UNIX, IOS, ANDROID, SYMBIAN, LINUX, or embedded operating systems such as VxWorks.

The present invention may also be implemented to work with various web browsers including but not limited to Internet Explorer, Mozilla Firefox, Safari and Opera that access and handle various types of web pages constructed with various mark-up languages such as HTML, HTML-5, XHTML, XML, etc. and the associated CSS (cascading style sheet) files and java-script files.

According to the invention, the primary objective of the invention is to provide a method for facilitating online personalized shopping information for a shopper which provides personalized information about at least one favorite provider of an item, said personalized information including special-sale items and/or services and popular items and/or provided by the at least one favorite provider. In one embodiment of the invention, the method providing personalized collections of at least one favorite item, the personalized collections including a shopping list related to the shopper and a shopping list related to a person other than the shopper. In a preferred embodiment of the invention, the personalized shopping information is provided via an electronic device in the form of a web application or on an online shopping Web page. Furthermore, the present invention is an online computer-implemented lawn care service quoting method using a computer which comprises of providing a lawn care service provider database associated with the computer, receiving at the computer a request for lawn care services as an estimate inquiry, posting said estimate inquiry in a web site accessible to a lawn care service provider.

In yet another embodiment of the invention, a user is provided with a search box in said online shopping Web page for searching at least one item from said items provided by said provider, also a user can select at least one favorite item in a shopping list.

Further in another embodiment of the invention the web application or on an online shopping Web page wherein a menu of providers and their related items and/or services they are providing. In the online shopping Web page or the web application a user can select at least one favorite service provider from said directory of providers providing items or services, also the shopping Web page or the web application provides a user with a directory of providers providing items or services.

Additionally in one embodiment of the invention the online shopping Web page or web application provides information about at least one specialty provider. Moreover the invention has a computer readable medium embodying the method for providing online shopping information and the method comprises of steps wherein a user can search at least one favorite provider for the shopper and provide information about at least one item in the at least one favorite provider. Also, in one embodiment of the invention, the system for providing online shopping assistance which comprises of at least one user terminal, at least one database containing information about providers of shopping items, means for searching at least one favorite shopping category for the shopper, means for searching at least one favorite provider for the shopper, means for providing information about at least one item in the at least one shopping category; and a means for providing information about at least one item provided by the at least one favorite provider.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

I claim:

1. A method for providing online personalized shopping information for a shopper, comprising the steps of:
providing personalized information about at least one favorite provider of an item, said personalized information including special-sale items and/or services and popular items and/or provided by the at least one favorite provider; and
providing personalized collections of at least one favorite item, the personalized collections including a shopping list related to the shopper and a shopping list related to a person other than the shopper.

2. The method of claim 1, wherein the personalized shopping information is provided on an online shopping Web page.

3. The method of claim 1, further includes providing via said online shopping Web page a directory of providers providing items or services.

4. The method of claim 1, further includes providing via said online shopping Web page a means to select at least one favorite service provider from said directory of providers providing items or services.

5. The method of claim 1 further includes providing a search box in said online shopping Web page for searching at least one item from said items provided by said provider.

6. The method of claim 1, further includes providing a menu of providers.

7. The method of claim 1, further includes providing information about at least one specialty provider.

8. A computer readable medium embodying a method for providing online shopping information, the method comprising the steps of:
searching at least one favorite provider for the shopper; and
providing information about at least one item in the at least one favorite provider.

9. An computer-implemented lawn care service quoting method using a computer, comprising:
providing a lawn care service provider database associated with the computer;
receiving at the computer a request for lawn care services as an estimate inquiry;
posting said estimate inquiry in a web site accessible to a lawn care service provider.

10. A system for providing online shopping assistance, comprising:
at least one user terminal;
at least one database containing information about providers of shopping items;
means for searching at least one favorite shopping category for the shopper;
means for searching at least one favorite provider for the shopper;
means for providing information about at least one item in the at least one shopping category; and
means for providing information about at least one item provided by the at least one favorite provider.

11. The computer system of claim 10, further implemented on a network environment including a global telecommunications network.
